(19) United States
(12) Patent Application Publication
(10) Pub. No.: US 2012/0110177 A1
(43) Pub. Date: May 3, 2012

(54) VPN FOR ACCESSING FILES STORED ON REMOTE COMPUTER

(75) Inventors: EUGENE MALOBRODSKY, Mountain View, CA (US); Rajesh M. Patel, Cupertino, CA (US)

(73) Assignee: ANCHORFREE, INC., Mountain View, CA (US)

(21) Appl. No.: 13/248,012

(22) Filed: Sep. 28, 2011

Related U.S. Application Data
(60) Provisional application No. 61/387,369, filed on Sep. 28, 2010.

(51) Int. Cl. G06F 15/173

(52) U.S. Cl. 709/225

(57) ABSTRACT

Systems and methods that enable the user to access user's files located on a remote computers via network in a secure manner. One or more implementations incorporate various components operating together to allow discovery of the hosts and enable secure access to the documents. At a higher level, various embodiments of the inventive concept may contain a client component and a server component. The server primarily contains two components—a web server component and component designed to assist with connectivity between different computers. In one or more embodiments of the inventive concept, the client may also include two components. Similar to the server, the client may incorporate a web component and the core component, which is configured to allow computers to be discovered and to share data.

### CROSS-REFERENCE TO RELATED PATENT APPLICATIONS

The present application relies on and claims benefit of priority under 35 U.S.C. 119 from U.S. provisional patent application Ser. No. 61/387,369, filed on Sep. 28, 2010, which is incorporated by reference herein in its entirety.

### BACKGROUND OF THE INVENTION

1. Field of the Invention

This invention relates in general to networking technology and, more particularly, to providing system and methods enabling users to securely access their files located on a remote computer, remote server or in the cloud over network.

2. Description of the Related Art

In many situations, user may need to remotely access files located on his or her home or work computer, such as personal desktop or laptop in a secure manner. For example, while traveling, a person may need to securely access certain records (e.g. bank statements) that are stored on a hard drive of his home computer, on a data storage system associated with a remote server or in the cloud over network.

Therefore, there is a need for systems and methods that enable the user to access user's files located on a remote computers via network in a secure manner.

### SUMMARY OF THE INVENTION

The inventive methodology is directed to methods and systems that substantially obviate one or more of the above and other problems associated with conventional techniques for enabling the user to access user's files located on a remote computers via network in a secure manner.

In accordance with one aspect of the inventive concept, there is provided a computerized system that enables access to files located on remote computers via network in a secure manner and an associated method and computer readable medium. The inventive system incorporates: a client component and a server component, the server component further including a web server component and core server component designed to assist with connectivity between computers. The client component further includes a web client component and a core client component, the core client component being configured to allow the computers to be discovered and to share data between the computers.

In accordance with another aspect of the inventive concept, there is provided a computer implemented method for enabling an access to files located on remote computers via network in a secure manner. The inventive method involves providing a client component and a server component, the server component further includes a web server component and core server component configured to assist with connectivity between computers and the client component further includes a web client component and a core client component. The inventive method further involves using the core client component to allow the computers to be discovered and to share data between the computers.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of the inventive system.

FIG. 2 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Aspects of the present invention provide systems and methods that allow users to remotely access their files located on remote computers, such as personal desktops or laptops, remote servers or in the cloud in a secure manner. In one or more embodiments the aforesaid file/data access system incorporate a virtual private networking (VPN) module providing VPN functionality in order to secure the file/data transfer from/to remote computer system. One or more embodiments of the inventive system provide a consumer VPN for access to user's own files stored on remote computer, which provides the user with the ability to get access to user's files and folders while the user is outside of his/her local area network.

In one or more embodiments, the VPN-based remote file access system incorporates a remote discovery and display module configured to enable the user to see computers or other hosts that are located either in their home or workplace. In one or more embodiments, the user's remote computers could be located anywhere behind a Router or NAT in a private network—referred to as “remote private network (RPN)”.

In one or more embodiments, the inventive system is configured to enable the discovery, display and access of multiple such RPNs. In the same or different embodiments, the system is configured to enable the user to save files directly on his computers located on those RPNs.

In one or more embodiments, the inventive system is configured to provide the user with ability to sync specific folders between machines on these RPNs. This includes the ability to sync between computers on different RPNs. In one or more embodiments, the above functionality of the inventive system is integrated with a private VPN system, such as HotspotShield (HSS) available from Anchorfree, Inc. of Mountain View, Calif. Various embodiments of the invention are designed to work independently even if the private VPN system is not installed or running. Various embodiments of the invention are also designed to allow if the private VPN system to control operation of the inventive software. In one exemplary implementation, the access to RPNs is allowed only if the user is connected to the through the private VPN system.

In one or more embodiments, the inventive system incorporates a module configured to allow a user to start the computer remotely, using such techniques as Wake on LAN. In this embodiment(s) the users are required to be authenticated before allowing access to any of the computers. In an alternative embodiment, the system or any part thereof is configured to change a setting on the computer of the user preventing it from going to sleep when the client is turned on. For example, the computer would be configured to turn off the monitor but keep the computer itself, including its processing functionality, awake.

In one or more embodiments, the inventive system incorporates a module or functionality for generating a web user interface configured to enable the user to manage the remote computers using the aforesaid web-based interface.

In one or more embodiments, the inventive system incorporates a module or functionality for enabling the users to see files without the agent through the Internet through a secure link.

In one or more embodiments, the inventive system incorporates a module or functionality for enabling sending a secure invite to an email address of anyone. Such invite could be used to inform the recipient of the fact that he was granted permission to access certain documents or other data located on remote computers.

In one or more embodiments, the inventive system incorporates a module or functionality for enabling the user to restore or recover its user name or password in case it is forgotten. Method for such password recovery are well-known to persons of ordinary skill in the art.

### Design and Implementation

One or more embodiments of the invention incorporate various components operating together to allow discovery of the hosts and allow secure access to the documents. In one or more embodiments, the aforesaid discovery mechanism uses servers to discover clients' IP address and opened communication ports. At a higher level, various embodiments of the inventive concept may contain a client component and a server component. Each of these components will be described in detail.

### Server Implementation

In one or more embodiments of the inventive concept, the server may include two components, including a web server component and a component designed to assist with connectivity between different computers on different RPNs. The web server component of the inventive system allows user to manage its computers and manage permissions to access these computers.

### Server Component for Accessing Files

In one or more embodiments of the inventive concept, this is the core server component that allows user to access files remotely. The primary purpose of this component is to allow the discovery of computer systems and assist with connectivity between different computer systems.

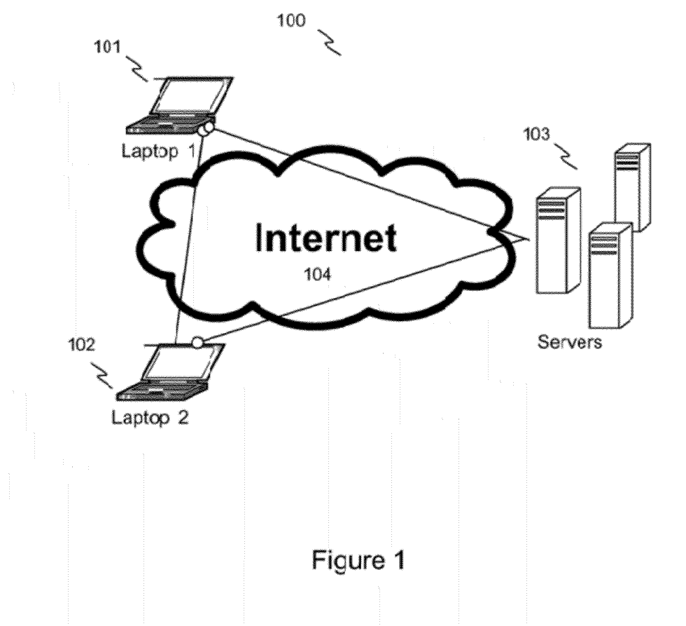

In one exemplary implementation 100 illustrated in FIG. 1, the user using a remote client is trying to access files on Laptop2 designated in FIG. 1 by numeral 102 from Laptop1 (101). It should be noted what while this example illustrates operation of the system using Laptops, one of ordinary skill in the art would appreciated that any computing device could be used for this purpose.

In the shown example, the Laptop1 and Laptop2 are physically separated and are on different RPNs. Under normal circumstances, Laptop1 and Laptop2 cannot find each other. In accordance with embodiments of the inventive concept, the discovery is done using the help of the aforesaid first server component 103. Thus, in this case, Laptop2 is discovered by Laptop1 using the inventive server(s) 103. Once Laptop2 is discovered, Laptop1 connects directly to Laptop2. The various phases of the aforesaid operation are described below.

### Start Phase

When either Laptop1 or Laptop2 starts, it first tries to register with one or more remote servers of the inventive system. During registration, the respective laptop attempts to authenticate and identify itself to the server. In one or more embodiments, every instance of client software will have a special serial number, by which it can be authenticated by the server. In an additional or alternative embodiment, the authentication of the client software may be performed, for example, using a certificate issued by a proper certificate authority. The one or more of the inventive servers keep track of which computer systems are currently registered therewith as well as the status of a communication channel it has open with the client to send commands.

In one or more embodiments, the client software installed on the Laptops incorporates a list of servers, which could provided at installation and dynamically updated on registration. The client registers with one of the servers on the list. After registration, the client keeps sending control packets to the server. In one implementation, different clients can register with different servers. In such a configuration, the aforesaid multi-server architecture requires frequent synchronization of client registration data between the servers. In an alternative embodiment, in order to reduce or eliminate the overhead associated with the aforesaid synchronization, the client registration and other information can be stored in a common database shared between the registration servers and the servers can read the necessary information from the aforesaid database. This eliminates the need for the synchronization and the associated overhead.

### Discovery Phase

In one or more embodiments of the inventive concept, during this phase, the client (in the shown example Laptop1) is trying to discover Laptop2. The Laptop 1 has no information on the IP address or the port that it can use to connect to Laptop2. However, this information is available to the server and is obtained during the client registration. The server authenticates the Laptop1, and after that it tries to check availability of the Laptop2. If the Laptop2 is available, the Laptop 2 is sent a command to authenticate the Laptop1. If the Laptop2 authenticates the Laptop1, it responds back to the server. Server then sends the port and IP address information to the Laptop1, which is used by the Laptop 1 for connecting to the Laptop 2. Laptop1, then can send packets directly to the Laptop2 using the aforesaid information received from the server. As would be appreciated by those of skill in the art, using the described discovery mechanism, the client can be behind a Router or a NAT and still be reachable without any modifications to the Router or NAT device.

In one or more embodiments, there is provided a mechanism for opening a port on each of the client's NAT or router if they are behind a firewall and for enabling the peers to connect directly to one another.

### Data Transfer Phase

During this phase, the Laptop1 is communicating with the Laptop2. In one or more embodiments of the inventive concept, the laptops are exchanging data without the servers being involved. The fact that the data transfer is conducted between laptops without participation of the server has an important benefit of reducing the bandwidth consumption at the server end, thus allowing the server to have a very large number of clients without slowing down the data transfer connections. In one or more embodiment, the direct communications between client computers during the data transfer phase is implemented using a common p2p technique called “UDP hole punching”, which is well-known to persons of ordinary skill in the art. This is done when the direct connection is impossible. In this case, the inventive system is configured to switch to a failover option—establish a connection between the laptops through the server, using it as a relay.

In one or more embodiments of the inventive concept, during the data transfer phase, each client (both Laptop1 and Laptop2) send control network packets to the server and listen to the response(s) from the server. This allows the inventive server to have a control over the data transfer channel. For example, the server can disconnect the aforesaid data transfer channel by sending control commands to each Laptop1 and Laptop2. Because there are many potential uses of this inventive data transfer methodology, including, without limitation, video broadcasting, file sharing with anonymous people and the like, the aforesaid control of the server over the data transfer channel is a very desirable feature.

It should be noted that in one or more embodiments, the user can access multiple remote machines at the same time.

### Idle Phase

In one or more embodiments of the inventive concept, during this phase, both laptops are idle and are not sharing any data between themselves. However, they keep registering with the server so that the server has information on how to establish connections with them when one of them needs to connect to the other.

As would be appreciated to persons of skill in the art, the described embodiment of the data transfer methodology is not limited to the use of laptops only and is likewise not limited by any particular network packet format, server ports, data transfer protocol, timeouts and the like implementation particulars.

### Web Server Component—Management Interface for Managing Computers

In one or more embodiments of the inventive concept, the server is implemented using a web server running on port 80 and supporting https on port 443. In one or more embodiments of the inventive concept, the web server is implemented using Apache/PHP software well known to persons of ordinary skill in the art. The web server component allows the user to manage its computers and, additionally, manage permissions to access these computers. In one or more embodiments of the inventive concept, the user is enabled to log into his/her account with the web server using a unique username and password. Once he/she has logged in, the inventive web server is configured to display to the user a list of computers that are registered to the user.

| Computer | Permissions | Status |
|---|---|---|
| My Home Computer | Browse Files | Available |
| My Home Laptop | | Unavailable |

In one or more embodiments of the inventive concept, using the inventive web server, the user can view the status of each registered machine. In one or more embodiments of the inventive concept, the active computers have an associated hyperlink enabled while inaccessible computers do not have hyperlinks enabled. Clicking on computer name gives detailed information about that computer. In one or more embodiments of the inventive concept, the following information may be displayed by the inventive web server:

Computer Name: My Home Computer

Default File Sharing Mode: Full Access (Other modes are Read Only and No Access)

In one or more embodiments of the inventive concept, clicking on Browse files lists the folders that the user has access to:

| Folder | Users | |
|---|---|---|
| Data | Joe (Full Access), | Add User, Modify User Rights |
| | Sam (Read Only) | |
| Photos | Joe (Read Only), | Add User, Modify User Rights |
| | Sam (Read Only) | |
| Work | None | Add User, Modify User Rights |

In one or more embodiments of the inventive concept, each folder has a list of users and their access permissions associated with it, as described above. The administrator can change the permissions for the users very easily by clicking on Modify User Rights link. This will bring up a user management page. Here the administrator can add/delete users or change their permissions to access different folders.

As would be appreciated by those of skill in the art, the described management interface is exemplary only and the invention is not limited by any specific implementation of this interface. Persons of skill in the art are well capable of designing any necessary management interface implementing the functionality of the inventive concept described herein.

### Client Component

In one or more embodiments of the inventive concept, the client may also include two components. Similar to the server, the client may incorporate a web component and the core component, which is configured to allow computers to be discovered and to share data.

### Core Client Component

In one or more embodiments of the inventive concept, the core client component is continuously executing on the computer system, such as by way of Windows service or a Linux/Unix daemon. The core client component will be referred hereto as file service. When the user starts the computer, the client starts automatically and tries to register itself with the inventive servers. As it would be appreciated by those of skill in the art, it is possible that the user may be not able to run file service all the time or install it as administrator. In this case, the registration is performed when the user starts the application whenever he/she is able to do so.

The client has a list of servers (including their IP addresses), which is provided to the client when the software is installed. In one or more embodiments of the inventive concept, the server list may be periodically updated when the client connects to one or more of the servers. The purposes for dynamically updating the list of servers include, without limitation:

1. To enable a better connectivity in case one of the servers is down.

2. In case the servers are blocked, the user has better chance of reaching one of the unblocked servers. This is important because this software is meant to be used with HSS and HSS is typically blocked. It should be noted that HSS is a secure protocol well known to persons of skill in the art.

3. Allow better management of IP addresses on the server. If the server IP address range changes, this will provide the client with the latest IP addresses.

In one or more embodiments of the inventive concept, once the client connects to the server, it maintains this connection for a predetermined time interval, such as 8 hours. In one or more embodiments of the inventive concept, there may be two exceptions:

1. If the client gets disconnected. In this case, the client will try to connect to a server using a predefined algorithm. This algorithm is similar to the service discovery algorithm for a private VPN client, such as Hotspot Shield available from Anchorfree, Inc. of Mountain View, Calif.

2. If the client is actively sharing data between different computers. In this case, the connection to the server is maintained until the sharing is done.

### Connection Process Details

As mentioned earlier, when the file service starts, it tries to connect to the servers by obtained the list of the servers from local cache. This list also has information about port and protocol along with IP address of the server. In one or more embodiments of the inventive concept, the primary purpose of it is to register so the server can obtain the client's IP address and port/protocol information. During the registration, the client generates a token (for example, a 256 bit hash) and includes it as a part of registration. Thereafter, the client continues sending control packets to the server to confirm that it is alive. In one or more embodiments of the inventive concept, every control packet to the server includes this token. If the server does not hear from the client, it assumes that the client is turned off or is unreachable. In one or more embodiments of the inventive concept, the client generates a new token every eight hours.

In one or more embodiments of the inventive concept, once the client is authenticated with the server, it sends control packets periodically (for example, every 20 seconds) to the server. In one or more embodiments of the inventive concept, these control packets are sent on a UDP port to the server. In one or more embodiments of the inventive concept, the server extracts the source port information from the packet. It then identifies the client from the token and maintains a state that links the client with this client source port and IP address information.

| | Source | Source | | | |
|---|---|---|---|---|---|
| Token | IP address | Port | Protocol | Last | Name |
| 851036CFD4912B671AB112 | 42.25.65.241 | 15636 | UDP | 1284051727 | Laptop 1 |
| 49BFB4115B | | | | | |
| 152036BFD492C8672A822C | 64.54.141.13 | 24245 | UDP | 1284051720 | Laptop 2 |
| 498F842258 | | | | | |

In addition, in one or more embodiments of the inventive concept, the following parameters are maintained per session: token; source IP address; source port; protocol; last name and current Status (Idle, sharing).

In the above example, two laptops from two different servers have registered and the server has received UDP control packets from each of them. The “Last” column indicates time when the last control packet was received from each of the laptops. In one or more embodiments of the inventive concept, this state is maintained during all phases. Now the user who is on Laptop2, wants to share files on Laptop1 which is at home. To accomplish that, the user goes to the website generated by the web server and clicks on Laptop1. This action can either load an ActiveX control on the browser or start a new application. This application will show the shared folder in explorer like view.

The below description illustrates how the ActiveX or the launched application gets the shared file information in accordance with an embodiment of the inventive system.

When the Laptop2 is trying to connect to the Laptop1, it sends a message to the inventive server. It should be noted that the exact message format is not critical to the present invention. Upon receiving this message, the server sends response to the Laptop1 with Laptop1's token and Laptop1's IP address, port and protocol information. Laptop2 then sends a message to Laptop1's IP address, port and protocol. In one or more embodiments of the inventive concept, it includes Laptop1's token in the aforesaid message. When Laptop1 sees this token in the message, it accepts the message. Laptop1 then sends a response to the message of Laptop2.

In one or more embodiments of the inventive concept, when Laptop2 is directly communicating with Laptop1, this communication channel is secured by encryption. This is achieved by creating a VPN channel on the port opened by Laptop1. When the Laptop1 receives a packet where the source port is different from the server port, it assumes that the packet is from another machine and it directs that packet to the VPN software, such as Openvpn, which is well known to persons of ordinary skill in the art.

In one or more embodiments, the inventive system incorporates a monitoring component an alert module operable to detect various changes within the system and generate various alerts for the users of the inventive system informing them of the aforesaid changes and suggesting taking certain actions. For example, if a particular service or user's laptop goes down or otherwise become unavailable, the monitoring component may detect such an occurrence and the alert module may be configured to send an email message to the owner of the laptop so he/she can restart file service if necessary. In one or more embodiments, the monitoring component may periodically query the various system components and transmit the information of the changes in the system to the alert module, which would generate alerts based on a predetermined configuration. In another embodiment, the monitoring component may be configured to detect the heartbeat(s) generated the various components of the system in order to detect components failures.

### Mobile Platform

In one or more embodiments, the mobile platform implementation of the inventive system is performed in a form of a client and not a server. The mobile implementation will allow access to user's content available in a remote location. In one or more embodiments, the user is provided with an ability to view content of the other allowed systems that have been shared with the user's account.

Share Component into Social Networks

In one or more embodiments, the system incorporates a social networking module, which provide an ability to securely share picture folders to the Social Networks. Specifically, users will have ability to create a social share folder that will allow them to upload their pictures into such social networking platforms, as Facebook, Tweeter, Google (Picassa), and the like using API of these systems.

In one or more embodiments, the system incorporates functionality to enable sharing of information from the mobile phone and to upload the shared to any of user's authenticated devices or other user's authenticated devices, including for example, user mother's computer.

### Blackberry, Windows and Nokia Support:

In one or more embodiments, a mobile client is provided that facilitates access to the files store on authorized computers. This client permits access to the data and enables editing or reading it. In addition, the mobile client enables the phones to access user's pictures or video folder and share it with user's friends by uploading it to the cloud, social networks or to user's authorized computers.

### Cloud Synchronization

In one or more embodiments, the inventive system incorporates a means for enabling a storage of files and other data in a cloud. In one or more embodiments, a facility is provided in order to upgrade to more space to enable sync from all the devices into the cloud for back-up purpose or storage without access to user's computers.

### Another Example

In an exemplary configuration, a Machine A is owned by a user Sam, while Machine B is owned by a user Joe. Machine C is owned by a Rachel, who is Sam's wife and is accessing it from the office. Suppose Sam wants Joe to be able to see his pictures located on his Machine A, which requires access to that machine in the read only mode. Rachel desires to upload some pictures on Machine A from her office Machine C, requiring access to the Machine A in the read/write mode.

Initially, Sam downloads the inventive client software component on the Machine A, Joe downloads client software on the Machine B and Rachel downloads the client software on the Machine C. All of the aforesaid three users create user accounts on the website generated by the aforesaid web server component, which is the part of the inventive system. While setting up the access permissions, the users may or may not allow access to their machines. For example, only Sam allows access to Machine A, while Joe and Rachel do not allow access to their respective Machines C and B.

On the inventive website generated by the web server component, Sam adds a Machine A. Sam asks Joe and Rachel for their user names and uses the inventive website to configure the system to allow access to Machine A by users with those user names. Specifically, Sam allows Joe a read only access to the Machine A and grants a read/write access to Rachel. When the Machine A is added, it is given a unique id (or hash) by the inventive system. Machine A is then allowed to register with the server with this unique Id in the manner described above. If it is determined during the registration that this unique ID is invalid, the machine is not allowed to register.

After the initial configuration and registration, when Rachel logs in to her account on the inventive website, she will see the Machine A. Joe will also see the Machine A. The software that is running on the Machine B registers with the server when the initial connection is made. In various embodiments, the software could be operating as a server or a client. Joe can allow Rachel to also get access to the respective machine by adding her email address to the appropriate access control list using the inventive website generated by the web server component.

In one or more embodiments, the inventive system incorporates a mechanism which allows user to choose which documents he/she wants to share and with what access restrictions. For example, the user may designate certain documents to be accessible for read-only and some documents to be accessible for both read and write operations.

In one or more embodiments, the inventive system incorporates a mechanism which allows user to share documents residing on their machines without uploading the documents to the servers. In an alternative embodiment, inventive system incorporates a mechanism, which allows user to share documents residing on their machines by uploading them on servers. In one or more embodiments, inventive system incorporates a mechanism, which allows users' clients to connect directly to each other while the described servers only aid in establishing connections. In one or more embodiments, inventive system incorporates a mechanism, which allows users to share not only data but also stream videos, including live videos, without sending the video data through the servers. In one or more embodiments, inventive system incorporates a mechanism, which allows users to share not only data but also to stream videos live by sending the associated data through the servers. In one or more embodiments, inventive system incorporates a mechanism, which allows user to control over what he can share and with whom.

In one or more embodiments, email address of the user is used as the user name in the inventive system, and the request of the invite can be sent to the email address where each the other person needs to confirm. The person can also ask Sam if he or she can join his share if they also have an account. If the request was sent to the person who does not have an account they can use the request link to register for new account and get only limited access until they download and install the client software.

In one or more embodiments, servers could also be used for temporary or permanent storage of files or back-ups if user's personal computers are unavailable for access or sync for any reason.

In one or more embodiments, the file signatures of the files synced and accesses are encrypted and split through all the computers on the network or that are part of the network. In other words, the user's data files and other information, including multimedia, may be stored across any number of computers connected to the network. Such computer may include personal computers of the other users, servers, etc. This could be accomplished using data striping technology, which is similar to the one used in RAIDS. In one or more embodiments, greater data redundancy could be utilized to protect the integrity of the stored data in the event of unavailability of a specific computer.

In one or more embodiments, if the computer fails, the files could be re-created from the cloud sync. The files or other data could be accessed from all the computers that are authenticated with the account and all these computers will act as a storage cloud with possibility of adding a server cloud.

It should be noted that the inventive concept is not limited to any specific type of data and the stored data that can be accessed may include any type of data what so ever, including, without limitation, video, music, pictures, documents, as well as computer state snapshots useful to enable computer system recovery.

As it would be appreciated by those of skill in the art, the inventive system could be used, for example, to gain access to iTunes library, enable printing, desktop sharing and provide ability to access user's files and folders from user's mobile device or a laptop that are located on a system outside of the network. The inventive system may additionally contain functionality to enable saving files directly to user's system at user's home and have the ability to sync specific folders between user's Laptop and a specific machine.

### Exemplary Computer Platform

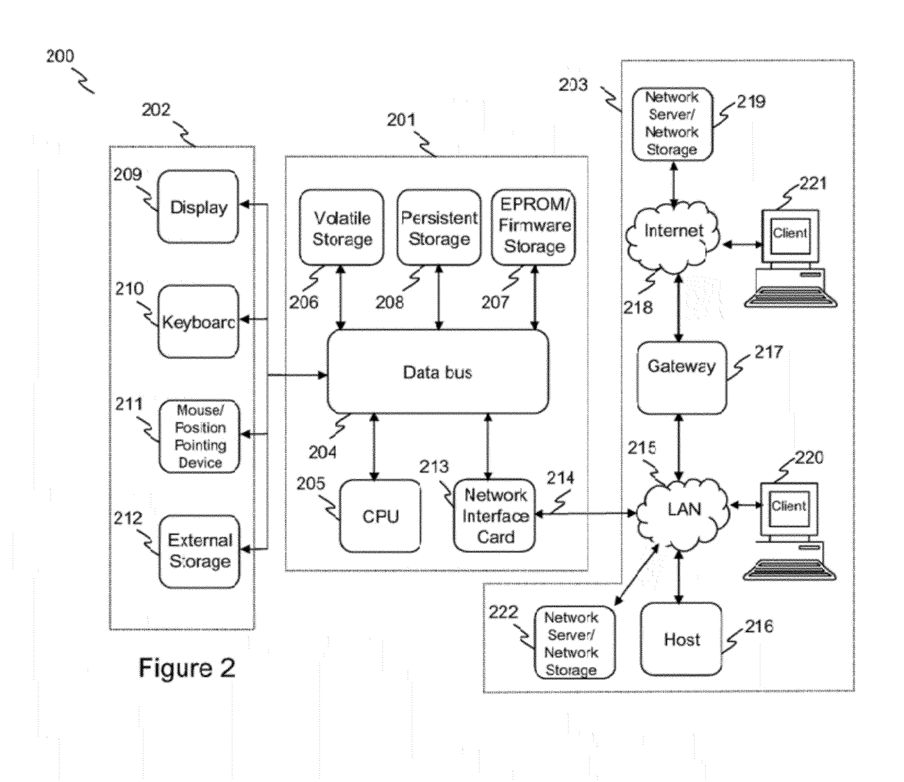

FIG. 2 illustrates an exemplary embodiment of a computer platform upon which the inventive system may be implemented.

FIG. 2 is a block diagram that illustrates an embodiment of a computer/server system 200 upon which an embodiment of the inventive methodology may be implemented. The system 200 includes a computer/server platform 201, peripheral devices 202 and network resources 203.

The computer platform 201 may include a data bus 205 or other communication mechanism for communicating information across and among various parts of the computer platform 201, and a processor 205 coupled with bus 201 for processing information and performing other computational and control tasks. Computer platform 201 also includes a volatile storage 206, such as a random access memory (RAM) or other dynamic storage device, coupled to bus 205 for storing various information as well as instructions to be executed by processor 205. The volatile storage 206 also may be used for storing temporary variables or other intermediate information during execution of instructions by processor 205. Computer platform 201 may further include a read only memory (ROM or EPROM) 207 or other static storage device coupled to bus 205 for storing static information and instructions for processor 205, such as basic input-output system (BIOS), as well as various system configuration parameters. A persistent storage device 208, such as a magnetic disk, optical disk, or solid-state flash memory device is provided and coupled to bus 201 for storing information and instructions.

Computer platform 201 may be coupled via bus 205 to a display 209, such as a cathode ray tube (CRT), plasma display, or a liquid crystal display (LCD), for displaying information to a system administrator or user of the computer platform 201. An input device 210, including alphanumeric and other keys, is coupled to bus 201 for communicating information and command selections to processor 205. Another type of user input device is cursor control device 211, such as a mouse, a trackball, or cursor direction keys for communicating direction information and command selections to processor 205 and for controlling cursor movement on display 209. This input device typically has two degrees of freedom in two axes, a first axis (e.g., x) and a second axis (e.g., y), that allows the device to specify positions in a plane.

An external storage device 212 may be coupled to the computer platform 201 via bus 205 to provide an extra or removable storage capacity for the computer platform 201. In an embodiment of the computer system 200, the external removable storage device 212 may be used to facilitate exchange of data with other computer systems.

The invention is related to the use of computer system 200 for implementing the techniques described herein. In an embodiment, the inventive system may reside on a machine such as computer platform 201. According to one embodiment of the invention, the techniques described herein are performed by computer system 200 in response to processor 205 executing one or more sequences of one or more instructions contained in the volatile memory 206. Such instructions may be read into volatile memory 206 from another computer-readable medium, such as persistent storage device 208. Execution of the sequences of instructions contained in the volatile memory 206 causes processor 205 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 205 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 208. Volatile media includes dynamic memory, such as volatile storage 206.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 205 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 205. The bus 205 carries the data to the volatile storage 206, from which processor 205 retrieves and executes the instructions. The instructions received by the volatile memory 206 may optionally be stored on persistent storage device 208 either before or after execution by processor 205. The instructions may also be downloaded into the computer platform 201 via Internet using a variety of network data communication protocols well known in the art.

The computer platform 201 also includes a communication interface, such as network interface card 213 coupled to the data bus 205. Communication interface 213 provides a two-way data communication coupling to a network link 215 that is coupled to a local network 215. For example, communication interface 213 may be an integrated services digital network (ISDN) card or a modem to provide a data communication connection to a corresponding type of telephone line. As another example, communication interface 213 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 213 sends and receives electrical, electromagnetic or optical signals that carry digital data streams representing various types of information.

Network link 213 typically provides data communication through one or more networks to other network resources. For example, network link 215 may provide a connection through local network 215 to a host computer 216, or a network storage/server 217. Additionally or alternatively, the network link 213 may connect through gateway/firewall 217 to the wide-area or global network 218, such as an Internet. Thus, the computer platform 201 can access network resources located anywhere on the Internet 218, such as a remote network storage/server 219. On the other hand, the computer platform 201 may also be accessed by clients located anywhere on the local area network 215 and/or the Internet 218. The network clients 220 and 221 may themselves be implemented based on the computer platform similar to the platform 201.

Local network 215 and the Internet 218 both use electrical, electromagnetic or optical signals that carry digital data streams. The signals through the various networks and the signals on network link 215 and through communication interface 213, which carry the digital data to and from computer platform 201, are exemplary forms of carrier waves transporting the information.

Computer platform 201 can send messages and receive data, including program code, through the variety of network(s) including Internet 218 and LAN 215, network link 215 and communication interface 213. In the Internet example, when the system 201 acts as a network server, it might transmit a requested code or data for an application program running on client(s) 220 and/or 221 through Internet 218, gateway/firewall 217, local area network 215 and communication interface 213. Similarly, it may receive code from other network resources.

The received code may be executed by processor 205 as it is received, and/or stored in persistent or volatile storage devices 208 and 206, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, pert, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the inventive VPN for accessing files stored on remote computer. It is intended that the specification and examples be considered as exemplary only, with a true scope and spirit of the invention being indicated by the following claims.

What is claimed is:

1. A computerized system for enabling an access to files located on remote computers via network in a secure manner, the system comprising: a client component and a server component, wherein the server component further comprises a web server component and core server component configured to assist with connectivity between computers and wherein the client component further comprises a web client component and a core client component, the core client component being configured to allow the computers to be discovered and to share data between the computers.

2. The computerized system of claim 1, further comprising a virtual private network (VPN) component configured to secure the data sharing between computers using data encryption.

3. The computerized system of claim 1, wherein the client core component causes the client component to register with the core server component.

4. The computerized system of claim 3, wherein the client core component causes the client component to register with the core server component using a list of stored server Internet Protocol (IP) addresses.

5. The computerized system of claim 4, wherein the list of stored server Internet Protocol (IP) addresses is periodically updated upon the registration.

6. The computerized system of claim 3, wherein the registration of the client component with the core server component causes the data on client component's IP address and open communication port to be stored with the server component.

7. The computerized system of claim 6, wherein the stored data on client component's IP address and open communication port is used in discovery of the corresponding computers.

8. The computerized system of claim 1, further comprising a display component configured to display to the user the data resources available to the user on remote computers.

9. The computerized system of claim 1, further comprising a permission configuration component configured to enable the user to specify access permission for other users to user's resources.

10. The computerized system of claim 1, wherein the permission configuration component comprises a user interface generating portion configured to receive from the user the access permission for user's resources.

11. The computerized system of claim 1, wherein the client component is installed on a mobile device.

12. The computerized system of claim 1, wherein before sharing data between the computers, each of the computers is authenticated with the server.

13. A computer implemented method for enabling an access to files located on remote computers via network in a secure manner, the method comprising:
providing a client component and a server component, wherein the server component further comprises a web server component and core server component configured to assist with connectivity between computers and wherein the client component further comprises a web client component and a core client component; and
using the core client component to allow the computers to be discovered and to share data between the computers.

14. The computer implemented method of claim 13, further comprising securing the data sharing between computers using data encryption.

15. The computer implemented method of claim 13, further comprising causing the client component to register with the core server component.

16. The computer implemented method of claim 15, further comprising causing the client component to register with the core server component using a list of stored server Internet Protocol (IP) addresses.

17. The computer implemented method of claim 16, wherein the list of stored server Internet Protocol (IP) addresses is periodically updated upon the registration.

18. The computer implemented method of claim 15, further comprising, upon registration of the client component with the core server component, storing data on client component's IP address and open communication port with the server component.

19. The computer implemented method of claim 18, further comprising using the stored data on client component's IP address and open communication port in discovery of the corresponding computers.

20. The computer implemented method of claim 13, further comprising displaying to the user the data resources available to the user on remote computers.
